(19) United States
(12) Patent Application Publication
(10) Pub. No.: US 2026/0287872 A1
(43) Pub. Date: Sep. 24, 2026

(54) METHOD FOR ADJUSTING A FLUORESCENCE IMAGE INTENSITY, AND FLUORESCENCE MICROSCOPE

(71) Applicant: Carl Zeiss Microscopy GmbH, Jena (DE)

(72) Inventors: Tim Dietz, Jena (DE); Mike Woerdemann, Jena (DE)

(73) Assignee: Carl Zeiss Microscopy GmbH, Jena (DE)

(21) Appl. No.: 19/571,843

(22) Filed: Mar. 19, 2026

(30) Foreign Application Priority Data
Mar. 24, 2025 (DE) 10 2025 111 145.6

(51) Int. Cl. G02B 21/00

(52) U.S. Cl. CPC G02B 21/0076; G02B 21/0032; G02B 21/0072; G02B 21/008

(57) ABSTRACT

A method adjusts a fluorescence image intensity for different fluorescence microscopes and for different times of image acquisition by a fluorescence microscope. The method includes recording a predetermined system configuration of a reference fluorescence microscope, generating a shading correction by a shading reference sample, acquiring a reference fluorescence image of an artificial reference calibration sample determining a mean reference fluorescence image intensity F̅I̅_{Ref} in a fluorescence channel of the reference fluorescence microscope, generating an adjustment shading correction, acquiring an adjustment fluorescence image of the artificial reference calibration sample, determining a mean adjustment fluorescence image intensity F̅I̅_{Used} in a fluorescence channel of the fluorescence microscope to be adjusted, calculating and storing a correction factor K_{FI} for the fluorescence channel from the mean reference fluorescence image intensity F̅I̅_{Ref} and the mean adjustment fluorescence image intensity F̅I̅_{Used} in accordance with

$${K}_{FI} = \frac{{\overline{FI}}_{R e f}}{{\overline{FI}}_{U s e d}} .$$

A fluorescence microscope can be adjusted with the method.

### CROSS-REFERENCE TO RELATED APPLICATIONS

This application claims priority to German Patent Application No. DE 10 2025 111 145.6, filed on Mar. 24, 2025, the content of which is hereby incorporated by reference in its entirety.

### BACKGROUND OF THE INVENTION

### Field of the Invention

The invention relates to a method for adjusting a fluorescence image intensity and to a fluorescence microscope.

Fluorescence microscopes are complex systems with many components that influence the image intensity of acquired sample images. Components that influence the intensity of acquired images include the samples themselves and, for example, the illumination power of the employed light source or the quantum efficiency of the detector used.

### Description of Related Art

The generation of identical or at least comparable image intensities for a specific sample using different microscopes and/or at different times using one microscope is relevant to specific applications. That is to say, measurement results that are as identical as possible or at least comparable should be recorded for one sample using different microscopes or at different times of use of one microscope. One established method for setting systems to apparently comparable illumination properties lies in measuring the illumination power in the sample plane and setting the illumination power accordingly. However, such methods neglect the influence of the detection path, the detector properties and the sensor area of the detector as partial regions of the illuminated surface.

DE 10 2014 112 002 A1 describes a method and a microscope for imaging a sample in which systematically induced inhomogeneities and/or unwanted brightness fluctuations in the acquired image are reduced. In essence, this is effected by a shading correction, in which a brightness correction image is created in order to compensate for non-uniformities in the illumination and imaging process. The brightness correction image is obtained from reference measurements in different regions of one or more comparison samples. The acquired images of the sample are then corrected on the basis of this brightness correction image. The correction can be performed continuously, wherein the acquired images are used as reference images in order to compensate for changes in the non-uniformity of the illumination over time. Influences of the sample examined in each case are not taken into account. This method cannot be used to adjust multiple systems either. A correction is performed by way of a pixel manipulation of the acquired raw image data. However, modifying the raw image data is often not desired by the customer and should be avoided.

U.S. Pat. No. 9,366,628 B2 discloses systems and methods for standardizing fluorescence microscopy systems. In practice, an absolute calibration of fluorescence microscopy systems, i.e. a calibration in relation to an absolute sensitivity reference, is very difficult bordering on impossible in practice since there are no stable, calibrated reference standards. Thus, U.S. Pat. No. 9,366,628 B2 proposes a separation of the effects of drift and normalization in order to carry out standardization of a fluorescence microscopy system. In order to normalize an imaging system, a first normalization image of a normalization sample is acquired using an imaging system to be standardized. A reference normalization image of the same normalization sample is acquired using a reference imaging system. Subsequently, the first normalization image and the reference normalization image are compared with each other, and a gamma value and an offset value for the imaging system to be standardized are determined on the basis the comparison. Moreover, a drift measurement is performed as a ratio of an average pixel intensity in the acquired image to the exposure time. In order to be able to finally carry out the standardization, the pixel intensity of each pixel in the acquired image is modified for the acquired digital image on the basis of the determined gamma and offset values and the drift measurement. The additional outlay required for performing the normalization and the drift correction is disadvantageous. The raw image data are also manipulated in this case.

US20160061654 A1 discloses a calibration apparatus and an associated method for calibrating microscopes. A calibration plate with two or more fixed fluorescent reference microscope slides is used to measure the intensity and shape of an illumination field for each combination of fluorescence channel (e.g. DAPI, FITC, CY3, CY5) and objective (e.g. 2×, 10×, 20×, 40×) in the microscope system to be calibrated. In order to achieve a consistent image intensity between multiple microscopes, the fixed fluorescent reference microscope slides (red, green, blue) of the calibration plate are used for the intensity calibration in order to determine an average intensity of each objective/channel combination such that the exposure times during the image acquisition can be scaled. However, the construction and use of the calibration plate require additional outlay and costs for a laboratory in which the microscopes present are intended to be calibrated in this way. The method also assumes that all microscopes used are compatible with the calibration plate and support the necessary automation. Moreover, the calibration must be repeated regularly in order to take account of changes in the microscopes over time.

US20130310268 A1 describes methods and systems for standardizing quantitative measurements on biological samples performed using a microscope system. For this purpose, a light source correction value for compensating for fluctuations in the intensity of the excitation source and an equipment intrinsic factor for correcting variations in the optical system used are ascertained. The correction values are applied to the measured data, i.e. acquired images of the biological sample, in order to obtain standardized, comparable results across different microscope systems. The method in US20130310268 A1 requires special calibration elements, for example a calibration cube, and this increases the measurement outlay. The correction factors are applied to the acquired images but not to the correction of the microscope system as such.

JP 2022122181 A discloses a correction parameter adjustment method and a data correction method serving to prevent differences in detection results on account of individual differences between microscopes. A correction parameter p is calculated from emission spectrum data of a first reference microscope and of a second microscope for a sample in order to subsequently correct the emission spectrum data of the second microscope for individual samples. A disadvantage is that this method assumes that there is a reference sample with the same emission intensity distribution as the sample to be measured, and this leads to restrictions on the possible uses of this method.

US20040051050 A1 describes reference equipment, a method and an apparatus for evaluating the performance of a confocal laser scanning microscope for two-dimensional, quantitative fluorescence measurements. The reference equipment consists of a substrate having, on the surface thereof, a reference fluorescent dye with a predetermined spatial distribution. This allows characterization of the following properties of the microscope: a) quantitative signal acquisition sensitivity, b) quantitative signal acquisition limit, c) uniformity of the confocal volume across the field of view, d) spatial resolution of the scanning process, e) dynamic behavior of the measured signal across the field of view. The method comprises scanning the reference equipment with the microscope to be evaluated in order to obtain measurement values which are subsequently used to determine correction factors. These correction factors can then be applied to correct measurement values of a sample to be examined, e.g. a DNA binding array. The intensity of the laser source in the laser scanning microscope is not regulated.

U.S. Pat. No. 11,747,280 B2 describes a system and method for calibrating a microscope or imaging system before image data of a sample are acquired. The calibration consists of several individual steps such as the implementation of a power output calibration in order to calibrate the repeatability of the measurements using the imaging equipment, and the implementation of an image intensity calibration in order to calibrate the reproducibility of the measurements with the imaging equipment and differences in detection efficiency between the channels. In order to obtain comparable results in relation to the acquired images, the image data acquired using the microscope or imaging system are multiplied by image correction factors on a pixel-by-pixel basis for each dye or marker. The acquired images are corrected.

### SUMMARY OF THE INVENTION

Given the aforementioned disadvantages in the prior art, it would be desirable to specify a method that allows an adjustment of the fluorescence intensity for different times and/or different microscopes in order to render the acquired fluorescence intensities comparable with one another. Acquiring an image of a sample (with constant properties) at different measurement times with one microscope or with different systems should produce identical image intensities when the same imaging properties, e.g. camera binning, exposure time, filter sets, etc., are used.

The invention includes but is not limited to the following embodiments:
1. A method for adjusting a fluorescence image intensity for different fluorescence microscopes and for different times of image acquisition by a fluorescence microscope, the method comprising:
recording a predetermined system configuration of a reference fluorescence microscope,
generating a shading correction by a shading reference sample using the reference fluorescence microscope,
acquiring a reference fluorescence image of an artificial reference calibration sample using a detector of the reference fluorescence microscope under the predetermined system configuration and using the previously generated shading correction,
determining a mean reference fluorescence image intensity F̅I̅_{Ref} of fluorescence, which was generated in the artificial reference calibration sample, in a fluorescence channel of the reference fluorescence microscope,
generating an adjustment shading correction by a shading reference sample using a fluorescence microscope to be adjusted,
acquiring an adjustment fluorescence image of the artificial reference calibration sample using a detector of the fluorescence microscope to be adjusted, under the predetermined system configuration and using the previously generated adjustment shading correction,
determining a mean adjustment fluorescence image intensity F̅I̅_{Used} of fluorescence, which was generated in the artificial reference calibration sample, in a fluorescence channel of the fluorescence microscope to be adjusted,
calculating and storing a correction factor K_{FI} for the fluorescence channel from the mean reference fluorescence image intensity F̅I̅_{Ref} and the mean adjustment fluorescence image intensity F̅I̅_{Used} in accordance with

$${K}_{FI} = \frac{{\overline{FI}}_{R e f}}{{\overline{FI}}_{U s e d}} ,$$

wherein for a fluorescence microscope to be adjusted, the correction factor K_{FI} is configured to be used to correct each adjustable system parameter, which depends linearly on the fluorescence image intensity, for the adjustment of the fluorescence image intensity,
wherein
the artificial reference sample is in the form of a homogeneously fluorescent glass substrate with emission bands between 400 nm and 850 nm.
2. The method as claimed in embodiment 1, wherein the adjustment fluorescence image of the artificial reference calibration sample is always acquired at the same location of the reference calibration sample.
3. The method as claimed in embodiment 1, wherein the method is carried out accordingly for each fluorescence channel of the fluorescence microscope to be adjusted.
4. The method as claimed in embodiment 1, wherein a radiation source intensity I_{S} of a radiation source of the fluorescence microscope is corrected by I_{S,adjustment}=K_{FI}·I_{S,original} with the correction factor K_{FI} when using the fluorescence microscope to acquire an image of a sample.
5. The method as claimed in embodiment 1, wherein an exposure time t is corrected by t_{adjustment}=K_{FI}·t_{original} with the correction factor K_{FI} when using the fluorescence microscope to acquire an image of a sample.
6. The method as claimed in embodiment 4, wherein the radiation source intensity I_{S,original} is set to a maximum of 50% for an adjustment of the fluorescence image intensity.
7. The method as claimed in embodiment 5, wherein the exposure time t_{original} is set to at least 10 ms for an adjustment of the fluorescence image intensity.
8. The method as claimed in embodiment 1, wherein system parameters which are linearly related to the fluorescence image intensity are corrected in advance.
9. The method as claimed in embodiment 1, wherein the recorded, predetermined system configuration and the ascertained correction factor K_{FI} are stored in a memory device in the fluorescence microscope to be adjusted.
10. The method as claimed in embodiment 1, wherein further qualified system reference calibration samples are generated in relation to the artificial reference calibration sample by virtue of interim fluorescence image intensities being ascertained in relation to the reference fluorescence microscope and being made available in a memory device of the fluorescence microscope to be adjusted, for the ascertainment of a corresponding correction factor K_{FI} for the fluorescence microscope to be adjusted.
11. The method as claimed in embodiment 1, wherein an adjustment of the fluorescence image intensity with the qualified system reference calibration sample on the fluorescence microscope is preceded by a check as to whether the actually present system configuration of the fluorescence microscope to be adjusted matches an entry from the memory device, wherein, in the case of a match, the fluorescence image intensity is measured and a corresponding correction factor K_{FI} is calculated using the interim fluorescence image intensity stored for the system configuration and, in the case of a non-match, a corresponding notification is output and neither measurement nor calculation is carried out.
12. A fluorescence microscope, which should be adjusted to match a reference fluorescence microscope, comprising:
an objective for imaging an object through an imaging beam path,
a radiation source for generating illumination radiation having at least two different wavelengths simultaneously,
at least one optical element for input coupling the illumination radiation into the imaging beam path,
a detector unit for detecting fluorescence from the object through the imaging beam path, and
a control unit configured to collect and evaluate measurement data from a detector of the detector unit, and
a memory device for storing calibration data for adjusting a fluorescence image intensity of the fluorescence microscope to that of a reference fluorescence microscope,
wherein the control unit is configured to implement the following:
checking whether a set system configuration of the fluorescence microscope matches an entry of calibration data in the memory device of the fluorescence microscope,
generating an adjustment shading correction by a shading reference sample using the fluorescence microscope to be adjusted,
acquiring an adjustment fluorescence image of a qualified system reference calibration sample using the detector of the fluorescence microscope to be adjusted, with the set system configuration and using the previously generated adjustment shading correction,
determining a mean adjustment fluorescence image intensity F̅I̅_{Used} of fluorescence, which was generated in the qualified system reference calibration sample, in a fluorescence channel of the fluorescence microscope to be adjusted,
calculating and storing a correction factor K_{FI} for the fluorescence channel from a mean interim fluorescence image intensity F̅I̅ᵢₙₜₑᵣ from the memory device and the mean adjustment fluorescence image intensity F̅I̅_{Used} in accordance with

$${K}_{FI , ref} = \frac{{\overline{FI}}_{R e f}}{{\overline{FI}}_{U s e d}} ,$$

wherein for the fluorescence microscope to be adjusted, the correction factor K_{FI} is configured to render each adjustable system parameter, which depends linearly on the fluorescence image intensity, for the adjustment of the fluorescence image intensity correctable,
wherein
the qualified system reference sample is in the form of a homogeneously fluorescent glass substrate with emission bands between 400 nm and 850 nm.
13. The fluorescence microscope as claimed in embodiment 12, wherein a radiation source intensity I_{S} of a radiation source of the fluorescence microscope is correctable by I_{S,adjustment}=K_{FI}·I_{S,original} with a correction factor K_{FI} when using the fluorescence microscope to acquire an image of a sample to be examined.
14. The fluorescence microscope as claimed in embodiment 12, wherein the radiation source is an LED light source, wherein the LED intensity is correctable by I_{LED,adjustment}=K_{FI}·I_{LED,original} with the correction factor K_{FI} when using the fluorescence microscope to acquire an image of a sample to be examined.
15. The fluorescence microscope as claimed in embodiment 12, wherein an exposure time t is correctable by means of t_{adjustment}=K_{FI}·t_{original} with a correction factor K_{FI} when using the fluorescence microscope to acquire an image of a sample to be examined.

### BRIEF DESCRIPTION OF THE DRAWINGS

FIG. 1 shows a schematic illustration of a first exemplary embodiment of a microscope according to the invention.

FIG. 2 shows a schematic illustration of a first exemplary embodiment of a method according to the invention.

### DETAILED DESCRIPTION OF THE INVENTION

This problem is solved by a method as described in independent embodiment 1. According to the invention, the method for adjusting a fluorescence image intensity for different fluorescence microscopes and for different times of image acquisition by a fluorescence microscope comprises the following steps:
recording a predetermined system configuration of a reference fluorescence microscope,
generating a shading correction by means of a shading reference sample using the reference fluorescence microscope,
acquiring a reference fluorescence image of an artificial reference calibration sample using a detector of the reference fluorescence microscope under the predetermined system configuration and using the previously generated shading correction,
determining a mean reference fluorescence image intensity F̅I̅_{Ref} of fluorescence, which was generated in the artificial reference calibration sample, in a fluorescence channel of the reference fluorescence microscope,
generating an adjustment shading correction by means of the shading reference sample or a further shading reference sample using a fluorescence microscope to be adjusted,
acquiring an adjustment fluorescence image of the artificial reference calibration sample using a detector of the fluorescence microscope to be adjusted, under the predetermined system configuration and using the previously generated adjustment shading correction,
determining a mean adjustment fluorescence image intensity F̅I̅_{Used} of fluorescence, which was generated in the artificial reference calibration sample, in a fluorescence channel of the fluorescence microscope to be adjusted,
calculating and storing a correction factor K_{FI} for the fluorescence channel from the mean reference fluorescence image intensity F̅I̅_{Ref} and the mean adjustment fluorescence image intensity F̅I̅_{Used} in accordance with

$${K}_{FI} = \frac{{\overline{FI}}_{R e f}}{{\overline{FI}}_{U s e d}} ,$$

wherein for a fluorescence microscope to be adjusted, the correction factor K_{FI} can be used to correct each adjustable system parameter, which depends linearly on the fluorescence image intensity, for the adjustment of the fluorescence image intensity, wherein
the artificial reference sample is in the form of a homogeneously fluorescent glass substrate with emission bands between 400 nm and 850 nm.

Predetermined system configurations are recorded on a reference fluorescence microscope, i.e. settings regarding objective selection, magnification, camera gain, etc. that should ultimately be used to examine samples in practice are adjusted and stored on the microscope. The system configurations are identical for the reference fluorescence microscope and the microscope to be adjusted; otherwise, an error message is output to the user and/or the adjustment/correction is not carried out. Subsequently, a shading correction by means of a shading reference sample is carried out using the reference fluorescence microscope in order to be able to remove brightness differences at the edge of the field of view of the microscope by calculation, even before real sample images are acquired. A shading reference sample is understood to mean a real, standardized sample which is used to improve the image quality by virtue of correcting brightness differences caused by various factors such as illumination, objective aberrations or the properties of the object/sample to be examined itself. Now, a reference fluorescence image of an artificial reference calibration sample is acquired using a detector of the reference fluorescence microscope under the predetermined system configuration and using the previously generated shading correction. A mean reference fluorescence image intensity F̅I̅_{Ref} of fluorescence, which was generated in the reference calibration sample, is determined in a fluorescence channel of the reference fluorescence microscope from the acquired reference fluorescence image and is stored, for example in the form of a table, in a memory. The same steps are now performed on a fluorescence microscope to be adjusted: An adjustment shading correction is generated by means of the already used shading reference sample or another shading reference sample using the fluorescence microscope to be adjusted. Subsequently, an adjustment fluorescence image of the artificial reference calibration sample is acquired using a detector of the fluorescence microscope to be adjusted, under the predetermined system configuration and using the previously generated adjustment shading correction, and a mean adjustment fluorescence image intensity F̅I̅_{Used} of a fluorescence, which was generated in the reference calibration sample, in a fluorescence channel of the fluorescence microscope to be adjusted is determined and stored, for example in the form of a table, in a memory. The adjustment shading correction or the adjustment fluorescence image linguistically identifies the distinction between the fluorescence microscope to be adjusted and other microscopes, e.g. the reference fluorescence microscope. Subsequently, a correction factor K_{FI} for the fluorescence channel under consideration is calculated from the mean reference fluorescence image intensity F̅I̅_{Ref} and the mean adjustment fluorescence image intensity F̅I̅_{Used} in accordance with

$${K}_{FI} = \frac{{\overline{FI}}_{R e f}}{{\overline{FI}}_{U s e d}}$$

and stored in an internal memory of the microscope to be adjusted, wherein for the fluorescence microscope to be adjusted, the correction factor K_{FI} can be used to correct each adjustable system parameter, which depends linearly on the fluorescence image intensity, for the adjustment of the fluorescence image intensity. The mean reference fluorescence image intensity F̅I̅_{Ref} and the mean adjustment fluorescence image intensity F̅I̅_{Used} identify the fluorescence image intensity over the entire fluorescence image acquired by the respective detector. This two-part calibration method is only rendered possible by the use of an artificial reference calibration sample. This reference calibration sample is characterized by its long-term stable properties. Advantageously, the reference calibration sample is formed from a homogeneously fluorescent glass substrate with high photostability, i.e. the properties and the structure of the sample remain stable and constant under the action of electromagnetic radiation. Moreover, the reference calibration sample has emission bands between 400 nm and 850 nm such that excitation radiation of a microscope is capable of exciting the fluorescent constituents of the sample which emit in wavelength ranges of interest in fluorescence microscopy. Advantageously, the reference calibration sample is formed from lanthanum phosphate glass, which is characterized by good chemical resistance and thermal stability and which has fluorescence properties that are advantageous and used for fluorescence microscopy.

The use of the artificial, long-term stable reference calibration sample ensures that the differences in the fluorescence image intensities between two successive image acquisitions deviate from each other by no more than 3% or 1%. That is to say, this ensures good long-term stability.

A further advantageous aspect of the method according to the invention is that even though the reference calibration sample already has constant homogeneous properties over its entire area, the adjustment fluorescence image of the artificial reference calibration sample is always acquired at the same location of the reference calibration sample. This compensates for residual fluctuations that may occur. For example, the reference calibration sample can be aligned using crosshairs or other biuniquely detectable marks on the reference calibration sample.

In a configuration of the method according to the invention, the method is carried out for each fluorescence channel of the fluorescence microscope to be adjusted. Accordingly, a correction factor K_{FI,x} is determined for each fluorescence channel x, where x is an index for different fluorescence channels x in the reference fluorescence microscope and corresponding to the fluorescence microscope to be adjusted. One and the same reference calibration sample can be used to this end since the reference calibration sample is capable of emitting fluorescence in all fluorescence regions of interest.

The advantage of this adjustment method is that this renders calibrated/adjusted fluorescence image intensities available for any desired sample if the respective correction factor K_{FI,x} is taken into account in the imaging settings of the adjusted fluorescence microscope. Taking account of the mean fluorescence image intensity over the entire acquired fluorescence image is sufficient for the accuracy of the adjustment. The use of an average value (mean value) of the fluorescence image intensity over the entire detector field or a part thereof leads to robust and reproducible measurements. It is also advantageous that a shading correction performed in advance means that the mean value of the fluorescence image intensity is not falsified by darker pixels at the edges of an acquired fluorescence image. The correction factor K_{FI} can be multiplied by adaptable, controllable or adjustable parameters of the microscope system which bring about a linear increase in the fluorescence image intensity.

In a preferred configuration of the method according to the invention, a radiation source intensity I_{S} of a radiation source of the fluorescence microscope is corrected by means of I_{S,adjustment}=K_{FI}·I_{S,original} with the correction factor K_{FI} when using a fluorescence microscope to acquire an image of a sample. The fluorescent illumination light sources have a linear increase in the optical power in relation to the controlled variable I_{S}. It is also advantageous if the radiation source used in the fluorescence microscope is autonomously set to internal standards to compensate for a temporal drift, for example. Within the meaning of the invention, autonomous setting of the radiation source to an internal standard is understood to mean that the radiation source used has a dedicated internal control used to autonomously control drift effects, aging of the radiation source, temperature fluctuations, etc. internally to a setpoint value in order thus to minimize the influence on the image acquisition. This ensures that the radiation source always emits the same radiant power. The radiation source can be an LED light source in a special configuration. The LED intensity I_{LED} of a light source of the fluorescence microscope is then corrected according to I_{LED,adjustment}=K_{FI}·I_{LED,original}.

The above-described configuration of the method is subject to the limitations of the value range of the controlled variable, generally from 0% to 100% in discrete steps of 0.1%. Since the quantity I_{S,adjustment} cannot exceed 100%, I_{S,original} must be significantly smaller to allow a sufficient buffer for the correction. The expected fluctuation range of the field must be taken into account when selecting the initial value for I_{S,original}. Therefore the radiation source intensity I_{S,original} should be set to no more than 50% for an adjustment of the fluorescence image intensity. Discretization limits the possible accuracy of the adjustment since the calculated value for I_{S,adjustment} has to be rounded. This might lead to relevant intensity deviations, especially in the case of a small I_{S,original} and a large correction factor K_{FI}. Corrective measures such as a change of the radiation source may counteract this.

In another preferred configuration of the method according to the invention, an exposure time t is corrected by means of t_{adjustment}=K_{FI}·t_{original} with the correction factor K_{FI} when using the fluorescence microscope to acquire an image of a sample. In general fluorescence imaging, the fluorescence image intensity increases linearly with the exposure time t. Under this precondition, it is possible to multiply the correction factor K_{FI} by the previous settings in order to enable adjusted fluorescence image intensities. This variant is also subject to the limitations of the value range of the controlled variable t, generally from 0.1 ms to 10 s in discrete steps of 0.1 ms. The expected range of fluctuations in the field must be taken into account when selecting the initial value for t_{original}. Therefore, the values for t should not be chosen to be shorter than 10 ms for the adjustment of the fluorescence image intensity.

The correction factors only apply to acquisitions with the same system configurations between reference fluorescence microscope and fluorescence microscope to be adjusted that were used during the adjustment method. If system parameters such as the camera gain are nevertheless modified when an image of the sample is acquired, it is therefore advantageous, within the scope of an additional method step, for those system parameters which are linearly related to the fluorescence image intensity to be corrected by the microscope user or for the user to be provided with a notification by the system to additionally adapt the corresponding system parameter so that the same fluorescence image intensities are output. The correction factors lose their validity as a result of a system parameter being modified with an unknown effect on the fluorescence image intensity, e.g. a change in a utilized filter, filter type or the radiation source, and so the adjustment procedure with the reference fluorescence microscope must be repeated with the modified system configuration.

It is advantageous for the adjustment method between the reference fluorescence microscope and the fluorescence microscope to be adjusted to be repeated at specific intervals in order to take account of effects due to changes in the system properties on account of use effects, soiling or drifting.

In a further configuration of the method according to the invention, the recorded, predetermined system configuration and the ascertained correction factor K_{FI} are stored in a memory device, for example in a database, in the fluorescence microscope to be adjusted. If a sample is examined using the fluorescence microscope and a fluorescence image of the sample is acquired, the fluorescence image intensity of the acquired image of the sample is corrected by the correction factor K_{FI} stored for the corresponding system configuration such that the acquired fluorescence image of the sample has a fluorescence image intensity which corresponds to the fluorescence image intensity should the sample have been examined/have its image acquired using the reference fluorescence microscope.

In another preferred configuration of the method according to the invention, further qualified system reference calibration samples are generated in relation to the artificial reference calibration sample by virtue of interim fluorescence image intensities being ascertained in relation to the reference fluorescence microscope and being made available in a memory or in a database in a memory of the fluorescence microscope to be adjusted, for the ascertainment of the corresponding correction factor K_{FI} for the fluorescence microscope to be adjusted. Normally, fluorescence microscopes are calibrated using an artificial master reference calibration sample before they are delivered to a customer. Since this master reference calibration sample is available only once, it is necessary to generate further qualified system reference calibration samples, which are adjusted to match the master reference calibration sample and can be made available to the customer for the calibration of their fluorescence microscope. For the adjustment of the qualified system reference calibration samples, interim fluorescence image intensities are ascertained in relation to the reference fluorescence microscope and the corresponding system configurations thereof and are stored in, for example, a database of the fluorescence microscope to be adjusted. Using the system reference calibration sample, the customer is now able to ascertain the correction factor K_{FI} for adjusting their fluorescence microscope using the suitable interim fluorescence image intensity, which depends on the chosen system configuration.

In a further configuration of the method according to the invention, an adjustment of the fluorescence image intensity with the qualified system reference calibration sample on the fluorescence microscope to be adjusted is preceded by a check as to whether the actually present system configuration of the fluorescence microscope to be adjusted matches an entry from the database, wherein, in the case of a match, the fluorescence image intensity is measured and a corresponding correction factor K_{FI} is calculated using the interim fluorescence image intensity stored for the system configuration and, in the case of a non-match, a corresponding notification is output and neither measurement nor calculation is carried out. This prevents incorrect correction values from being output. The same applies during the real measurement with the fluorescence microscope. Before the fluorescence image intensity of a sample to be examined is acquired and measured, a check is carried out as to whether the actually present system configuration of the employed fluorescence microscope matches an entry from the database, wherein, in the case of a match, the fluorescence image intensity is measured and corrected using the appropriate correction factor K_{FI}. In the case of a non-match, an appropriate notification is output, and the microscope user can readjust the system configuration again. This prevents incorrect measurement values from being output.

The problem is also solved by independent embodiment 11. The fluorescence microscope according to the invention, which should be adjusted to match a reference fluorescence microscope, comprises:
an objective for imaging an object through an imaging beam path,
a radiation source for generating illumination radiation having at least two different wavelengths simultaneously,
at least one optical element for input coupling the illumination radiation into the imaging beam path,
a detector device for detecting fluorescence from the object through the imaging beam path and
a control unit configured to collect and evaluate measurement data from the detector unit and
a memory device for storing calibration data for adjusting a fluorescence image intensity of the fluorescence microscope to that of a reference fluorescence microscope, wherein the control unit is configured to implement the following steps:
   checking whether a set system configuration of the fluorescence microscope matches an entry of calibration data in the memory device of the fluorescence microscope,
   generating an adjustment shading correction by means of a shading reference sample using the fluorescence microscope to be adjusted,
   acquiring an adjustment fluorescence image of a qualified system reference calibration sample using the detector of the fluorescence microscope to be adjusted, with the set system configuration and using the previously generated adjustment shading correction,
   determining a mean adjustment fluorescence image intensity F̅I̅_{Used} of fluorescence, which was generated in the qualified system reference calibration sample, in a fluorescence channel of the fluorescence microscope to be adjusted,
   calculating and storing a correction factor K_{FI} for the fluorescence channel from a mean interim fluorescence image intensity F̅I̅ᵢₙₜₑᵣ from the database and the mean adjustment fluorescence image intensity F̅I̅_{used} in accordance with

$${K}_{FI} = \frac{{\overline{FI}}_{inter}}{{\overline{FI}}_{U s e d}} ,$$

wherein for the fluorescence microscope to be adjusted, the correction factor K_{FI} can render each adjustable system parameter, which depends linearly on the fluorescence image intensity, for the adjustment of the fluorescence image intensity correctable, wherein
the qualified system reference sample is in the form of a homogeneously fluorescent glass substrate with emission bands between 400 nm and 850 nm.

The fluorescence microscope according to the invention and, in particular, the control unit of the fluorescence microscope can preferably be configured to carry out one of the variants of the method according to the invention described here.

The variants of the method according to the invention described here can be carried out using the fluorescence microscope according to the invention.

The term illumination beam path comprises the radiation source and all, in particular optical, beam-guiding and beam-modifying components, e.g. lenses, mirrors, prisms, gratings, filters, stops, beam splitters, by means of which and via which the excitation light is guided from a radiation source, in particular a light source, to the sample to be examined. The illumination beam path may comprise an illumination objective. The illumination objective and a microscope objective can each be microscope objectives of a type known per se. In principle, the illumination objective and the microscope objective can also be separate objectives. However, in preferred embodiments, the illumination objective and the microscope objective are one and the same objective.

The excitation light is electromagnetic radiation, in particular in the visible spectral range and in adjoining ranges. The excitation light can also be referred to as illumination light; these two terms are used synonymously for the most part in this description. The radiation source can be any light source capable of supplying the excitation light with a desired wavelength or desired wavelengths and with a suitable intensity. For example, the light source might be a laser, a plurality of lasers, an LED, an LED module or a combination of these components. The excitation light can be coherent light, at least partially coherent light or non-coherent light. In principle, the reference calibration sample or the qualified system reference calibration sample may be any type of sample having long-term stable properties. As already described above in relation to the reference calibration sample, the qualified system reference calibration sample is advantageously formed from a homogeneously fluorescent glass substrate. The qualified system reference calibration sample also has emission bands between 400 nm and 850 nm such that excitation radiation of a microscope is capable of exciting the fluorescent constituents of the sample which emit in the wavelength range of interest in fluorescence microscopy. Advantageously, the qualified system reference calibration sample is also formed from lanthanum phosphate glass, which is characterized by good chemical resistance and thermal stability and which has fluorescence properties that are advantageous and used for fluorescence microscopy. The microscope according to the invention and the method according to the invention are suitable for examining biological samples in particular. In principle, the sample to be examined can be any kind of sample.

Light emitted by the reference calibration sample or the qualified system reference calibration sample as a consequence of the irradiation by the illumination or excitation light is referred to as emission radiation or else emission light and reaches the detector, e.g. a camera, via the detection beam path. In order for the light to be able to be referred to as emission light, it is only necessary that the light is emitted by the illuminated sample or that in any case it comes from the illuminated sample. Typically, the emission light can be fluorescence which is radiated or emitted by the reference calibration sample or the qualified system reference calibration sample, in particular dye molecules present there, as a consequence of the irradiation by the excitation light. The emission light can also be reflected, transmitted and scattered illumination light. The only requirement made in respect of the contrast-imparting principle is that the reference calibration sample or the qualified system reference calibration sample emits emission light as a consequence of the irradiation by the excitation light.

The emission light reaches the detector, e.g. a camera, via the detection beam path. Here, the term detection beam path denotes the detector and all beam-guiding and beam-modifying, in particular optical, components, e.g. lenses, mirrors, prisms, gratings, filters, stops, beam splitters, by means of which and via which the emission radiation is guided from the reference calibration sample or the qualified system reference calibration sample as far as the detector. Expediently, a sensor plane of the detector can be arranged in a plane which is optically conjugate to a focal plane of the microscope objective.

The type of detector used to detect the emission radiation generally depends on the type of microscope. In embodiments of the invention, the detector may be formed from a plurality of individual detectors. For example, the detector may comprise a two-dimensionally spatially resolving photodetector, e.g. one or more cameras, a one-dimensionally spatially resolving detector, e.g. a linear detector arrangement, or a single photodetector, e.g. a point-type photodetector. Specifically, the detector can comprise at least one of the following elements or one of the following components: CCD element, CMOS element, SPAD element, PMT.

The term control unit is understood to mean all hardware and software components that interact with the components of the optical apparatus according to the invention, i.e. the fluorescence microscope, for the intended functionality of the latter. In particular, the control unit can comprise a computing device, for example a PC, and a camera controller capable of reading out measurement signals. Measurement data of the detector are the measurement data generated by the detector upon the irradiation by emission light. The memory device may be a memory device of a known type. For example, it may comprise a database. A database within the meaning of the invention is understood to mean a memory from which values relevant to the adjustment method can be read.

In a configuration of the fluorescence microscope according to the invention, a radiation source intensity I_{S} of a radiation source of the fluorescence microscope is correctable by means of I_{S,adjustment}=K_{FI}·I_{S,original} with the correction factor K_{FI} when using the fluorescence microscope to acquire an image of a sample to be examined.

In another configuration of the fluorescence microscope according to the invention, the radiation source is an LED light source, wherein the LED intensity is correctable by means of I_{LED,adjustment}=K_{FI}·I_{LED,original} with the correction factor K_{FI} when using the fluorescence microscope to acquire an image of a sample to be examined.

In a further configuration of the fluorescence microscope according to the invention, an exposure time t is correctable by means of t_{adjustment}=K_{FI}·t_{original} with the correction factor K_{FI} when using the fluorescence microscope to acquire an image of a sample to be examined.

Advantageous exemplary embodiments of the microscope according to the invention and advantageous variants of the method according to the invention are described below, in particular in association with the dependent embodiments and the figures. The features presented below can represent an aspect of the invention both individually and in different combinations with one another.

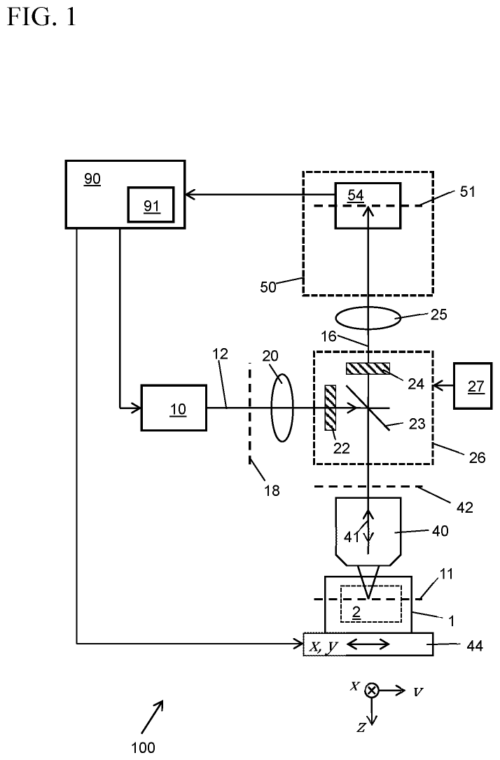

A first exemplary embodiment of a microscope 100 according to the invention will be described with reference to FIG. 1.

The microscope 100 firstly comprises an illumination beam path having a radiation source 10, e.g. a laser, a laser module or an LED or multiple LEDs, for emitting excitation light, wherein the illumination beam path is configured to direct or guide the excitation light into a sample region 1. In the example shown, the illumination beam path furthermore comprises a tube lens 20, an excitation filter 22, a main beam splitter 23 and a microscope objective 40. The excitation filter 23 is a transmission filter which passes only those spectral components of the excitation light 12 which are desired for the respective experiment or the calibration. The tube lens 20 generates an intermediate image plane 18, i.e. a plane which is optically conjugate to a plane 11 in a sample 2 in the sample space 1. In the illumination beam path, the excitation light 12 passes through the intermediate image plane 18 and via the tube lens 20 and the excitation filter 23 to the main beam splitter 23 and is reflected there in the direction of the microscope objective 40. The excitation light 12 then passes through a back focal plane 42 of the microscope objective 40 and is subsequently directed from the microscope objective 40 into the sample space 1. The sample 2 can be a biological sample for real experiments or a reference calibration sample or a qualified system reference calibration sample for the calibration, and it is prepared with dyes that can be excited by the excitation light 12. The wavelength and intensity of the excitation light 12 can be chosen suitably with regard to the sample 2 and the dyes used. The radiation source 10 can consist of a multiplicity of different lasers or LEDs. The wavelength and/or intensity can be settable.

Furthermore, the microscope 100 comprises a detection beam path with the microscope objective 40 and a detector 54 for detecting emission light 16 emitted by the reference calibration sample or the qualified system reference calibration sample 2 in the sample region 1 as a consequence of being irradiated with the excitation light 12. The detection beam path is configured to direct the emission light 16 to the detector 54. In the example shown, the microscope 100 is a wide-field fluorescence microscope and the detector 50 is a camera, i.e. a field of view (FOV) of the detection beam path is imaged onto a sensor plane 51 of the camera 50. The sensor plane 51 is optically conjugate to a plane 11 in the sample space 1. The emission light 16 emitted by the sample 2 can typically be red-shifted fluorescence emitted by the dyes in the sample 2. The main beam splitter 23 is configured such that it transmits the red-shifted emission light 16 and reflects the excitation light 12. This prevents large parts of the excitation light 12 scattered back from the sample space 1 from being able to pass in the direction of the camera 50. In the detection beam path, the emission light 16 emitted by the reference calibration sample or the qualified system reference calibration sample 2 is received by the microscope objective 40, passes through the main beam splitter 23 and an emission filter 24 and is then imaged by a tube lens 25 into the sensor plane 51 of the camera 50. The emission filter 24 is a transmission filter which passes only those spectral components of the emission light 16 which should be measured for the respective experiment/the respective calibration.

In the exemplary embodiment shown, the excitation filter 22, the main beam splitter 23 and the emission filter 24 are arranged in an interchangeable filter cube or filter module 26. In the exemplary embodiment shown, there is a schematically illustrated interchange apparatus 27 which serves to introduce different filter cubes (not shown in FIG. 1) which in each case have different excitation filters, main beam splitters and/or emission filters. For example, the interchange apparatus may comprise a linear slide, by means of which a respective desired filter cube 26 can be introduced into the beam path in a direction perpendicular to the plane of the drawing. Changing the filter cube in each case realizes a different system configuration of the excitation beam path and of the detection beam path.

For example, the light source 10 could also emit excitation light 12 with a different spectral composition for each of the system configurations.

From among the components of excitation filter 22, main beam splitter 23 and emission filter 24, only the main beam splitter 23 is mandatory for directing the excitation light 12 in the direction of the sample 2. Consequently, the interchange device 27 could also be an interchange device serving only to introduce a different main beam splitter into the beam path in each case.

Furthermore, the microscope 100 in the example shown comprises a mechanical drive 44, in particular an automated mechanical drive, for setting a relative lateral position x, y between the sample 2 and the microscope objective 40 with respect to an optical axis 41 of the microscope objective 40 and a control unit 90, e.g. a PC, for evaluating the emission light 16 detected by the detector 54. In the example shown, the optical axis 41 of the microscope objective 40 extends in the direction of the z-axis. The mechanical drive 44 can be e.g. part of a motorized sample stage and, in the example shown, serves to set a predefined position of the sample 2, i.e. predefined x-, y-coordinates of the sample 2 with respect to the optical axis 41, and always exactly align a qualified system reference calibration sample. A right-handed orthogonal coordinate system x, y, z is illustrated below the mechanical drive 44. It is advantageous for the reference calibration sample or qualified system reference calibration sample 2 to have crosshairs which are visible in the bright field in order to be able to enable a defined determination of location and focusing on the sample 2.

According to the invention, the control unit 90 comprises a memory device 91 in which, first of all, system configurations of the microscope are stored. Furthermore, the memory device 91 stores interim fluorescence image intensities, which were measured or calculated in advance by measurements performed by a reference fluorescence microscope 200 and/or various system integration systems 300. These values can also be stored in a database and loaded therefrom. Moreover, illumination settings for the shading correction may be stored, e.g. in a lookup table, in order to ensure that the image representation of the artificial reference calibration sample 250 and the qualified system reference calibration sample 350 at the customer are identical. Once a setting has been created, the parameterization can be blocked in order to avoid process errors and erroneous data.

Settings created in advance using a specific system configuration and stored in the memory are compared before each measurement with the system configuration set for the current imaging process. The customer is only able to use the settings if the current imaging settings match one of the stored system configurations.

According to the invention, the control unit 90 is configured to calculate a correction value K_{FI} 413 using the interim fluorescence intensities 213, the predetermined system configurations for a fluorescence microscope 400 to be adjusted originating from the adjustment fluorescence image acquired using a qualified system reference calibration sample 350 by means of the fluorescence microscope 400 to be adjusted. Said correction value is then used for the adjustment of subsequently acquired fluorescence image intensities of examined samples.

For this purpose, the method according to the invention or one of the variants of the method according to the invention described in the general part of the description can be carried out by the microscope 100.

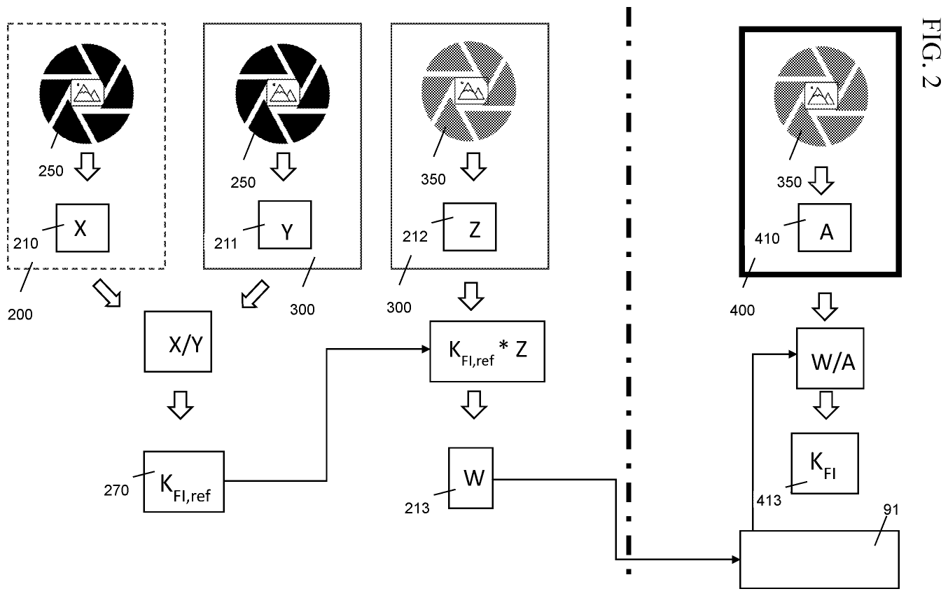

FIG. 2 schematically shows the method according to the invention for adjusting a fluorescence image intensity for different fluorescence microscope systems. The dashed fluorescence microscope system is the reference fluorescence microscope 200, with which the fluorescence image intensity X 210 is measured for an artificial reference calibration sample 250 in a first exemplary embodiment. A fluorescence image intensity Y 211 from the same artificial reference calibration sample 250 is measured with a fluorescence microscope 300 to be adjusted. Whether the system configurations of the reference fluorescence microscope 200 and of the fluorescence microscope 300 to be adjusted match was checked in advance in each case. Moreover, a shading correction is carried out using a shading reference sample; this is not illustrated. A correction value K_{FI,ref} 270 is calculated from the measured fluorescence image intensity X 210 and measured fluorescence image intensity Y 211. To generate qualified system reference calibration samples 350, the fluorescence image intensity Z 212 of this system reference calibration samples 350 is measured with the fluorescence microscope 300. The correction value K_{FI,ref} 270 is used to calculate an interim fluorescence image intensity W 213 therefrom, and the latter is stored in a memory 91 of the fluorescence microscopes 100, 400. This interim fluorescence image intensity W 213 is made available to the customer so that they can adjust their microscope system 400. For example, the customer can calculate a new correction value K_{FI} 413 from

$${K}_{F 1} = \frac{\overline{W}}{\overline{A}}$$

by means of the qualified system reference calibration sample 350 made available to them and the interim fluorescence image intensity W 213, in order to adjust the acquired fluorescence image intensities in relation to the original reference fluorescence microscope 100, 200. The fluorescence image intensity A is the fluorescence image intensity, acquired by means of the detector, relating to the fluorescence radiation emitted by the qualified system reference calibration sample 350 in the customer fluorescence microscope 400 to be adjusted. The mean value over the field of view of the detector is calculated for the fluorescence image intensities, i.e. the ascertained fluorescence image intensities X, Y, Z and A are mean values over the field of view of the detector.

### LIST OF REFERENCE SIGNS

1 Sample region
2 Sample
10 Radiation source, light source, e.g. laser or LED source
12 Illumination radiation, illumination light, excitation light
16 Emission radiation or emission light emitted by sample 2 in sample region 1
20 Lens in the excitation beam path
22 Excitation filter
23 Main beam splitter
24 Emission filter
25 Lens in the detection beam path
26 Filter cube
27 Interchange device for filter cube 26
40 Microscope objective
41 Optical axis of the microscope objective 40
44 Mechanical drive, xy-displacement stage
50 Detection unit
51 Detection plane, optically conjugate to the sample plane 11
54 Detector, camera
90 Control unit
91 Memory, memory device
100 Microscope according to the invention
200 Reference fluorescence microscope
210 . . . 212 Measured fluorescence image intensities
213 Interim fluorescence image intensity
250 Artificial reference calibration sample
270 Correction value in relation to the reference fluorescence microscope
300 Fluorescence microscope to be adjusted
350 Qualified system reference calibration sample
400 Fluorescence microscope of a customer, customer system to be adjusted
410 Fluorescence image intensity measured with the customer system
413 Correction value for a customer system to be adjusted

1. A method for adjusting a fluorescence image intensity for different fluorescence microscopes and for different times of image acquisition by a fluorescence microscope, the method comprising:
recording a predetermined system configuration of a reference fluorescence microscope,
generating a shading correction by a shading reference sample using the reference fluorescence microscope,
acquiring a reference fluorescence image of an artificial reference calibration sample using a detector of the reference fluorescence microscope under the predetermined system configuration and using the previously generated shading correction,
determining a mean reference fluorescence image intensity F̅I̅_{Ref} of fluorescence, which was generated in the artificial reference calibration sample, in a fluorescence channel of the reference fluorescence microscope,
generating an adjustment shading correction by a shading reference sample using a fluorescence microscope to be adjusted,
acquiring an adjustment fluorescence image of the artificial reference calibration sample using a detector of the fluorescence microscope to be adjusted, under the predetermined system configuration and using the previously generated adjustment shading correction,
determining a mean adjustment fluorescence image intensity F̅I̅_{Used} of fluorescence, which was generated in the artificial reference calibration sample, in a fluorescence channel of the fluorescence microscope to be adjusted,
calculating and storing a correction factor K_{FI} for the fluorescence channel from the mean reference fluorescence image intensity F̅I̅_{Ref} and the mean adjustment fluorescence image intensity F̅I̅_{Used} in accordance with
$${K}_{FI} = \frac{{\overline{FI}}_{R e f}}{{\overline{FI}}_{U s e d}} ,$$
wherein for a fluorescence microscope to be adjusted, the correction factor K_{FI} is configured to be used to correct each adjustable system parameter, which depends linearly on the fluorescence image intensity, for the adjustment of the fluorescence image intensity,
wherein
the artificial reference sample is in the form of a homogeneously fluorescent glass substrate with emission bands between 400 nm and 850 nm.

2. The method as claimed in claim 1, wherein the adjustment fluorescence image of the artificial reference calibration sample is always acquired at the same location of the reference calibration sample.

3. The method as claimed in claim 1, wherein the method is carried out accordingly for each fluorescence channel of the fluorescence microscope to be adjusted.

4. The method as claimed in claim 1, wherein a radiation source intensity I_{S} of a radiation source of the fluorescence microscope is corrected by I_{S,adjustment}=K_{FI}·I_{S,original} with the correction factor K_{FI} when using the fluorescence microscope to acquire an image of a sample.

5. The method as claimed in claim 1, wherein an exposure time t is corrected by t_{adjustment}=K_{FI}·t_{original} with the correction factor K_{FI} when using the fluorescence microscope to acquire an image of a sample.

6. The method as claimed in claim 4, wherein the radiation source intensity I_{S,original} is set to a maximum of 50% for an adjustment of the fluorescence image intensity.

7. The method as claimed in claim 5, wherein the exposure time t_{original} is set to at least 10 ms for an adjustment of the fluorescence image intensity.

8. The method as claimed in claim 1, wherein system parameters which are linearly related to the fluorescence image intensity are corrected in advance.

9. The method as claimed in claim 1, wherein the recorded, predetermined system configuration and the ascertained correction factor K_{FI} are stored in a memory device in the fluorescence microscope to be adjusted.

10. The method as claimed in claim 1, wherein further qualified system reference calibration samples are generated in relation to the artificial reference calibration sample by virtue of interim fluorescence image intensities being ascertained in relation to the reference fluorescence microscope and being made available in a memory device of the fluorescence microscope to be adjusted, for the ascertainment of a corresponding correction factor K_{FI} for the fluorescence microscope to be adjusted.

11. The method as claimed in claim 1, wherein an adjustment of the fluorescence image intensity with the qualified system reference calibration sample on the fluorescence microscope is preceded by a check as to whether the actually present system configuration of the fluorescence microscope to be adjusted matches an entry from the memory device, wherein, in the case of a match, the fluorescence image intensity is measured and a corresponding correction factor K_{FI} is calculated using the interim fluorescence image intensity stored for the system configuration and, in the case of a non-match, a corresponding notification is output and neither measurement nor calculation is carried out.

12. A fluorescence microscope, which should be adjusted to match a reference fluorescence microscope, comprising:
an objective for imaging an object through an imaging beam path,
a radiation source for generating illumination radiation having at least two different wavelengths simultaneously,
at least one optical element for input coupling the illumination radiation into the imaging beam path,
a detector unit for detecting fluorescence from the object through the imaging beam path, and
a control unit configured to collect and evaluate measurement data from a detector of the detector unit, and
a memory device for storing calibration data for adjusting a fluorescence image intensity of the fluorescence microscope to that of a reference fluorescence microscope,
wherein the control unit is configured to implement the following:
checking whether a set system configuration of the fluorescence microscope matches an entry of calibration data in the memory device of the fluorescence microscope,
generating an adjustment shading correction by a shading reference sample using the fluorescence microscope to be adjusted,
acquiring an adjustment fluorescence image of a qualified system reference calibration sample using the detector of the fluorescence microscope to be adjusted, with the set system configuration and using the previously generated adjustment shading correction,
determining a mean adjustment fluorescence image intensity F̅I̅_{Used} of fluorescence, which was generated in the qualified system reference calibration sample, in a fluorescence channel of the fluorescence microscope to be adjusted,
calculating and storing a correction factor K_{FI} for the fluorescence channel from a mean interim fluorescence image intensity F̅I̅ᵢₙₜₑᵣ from the memory device and the mean adjustment fluorescence image intensity F̅I̅_{Used} in accordance with
$${K}_{FI , ref} = \frac{{\overline{FI}}_{inter}}{{\overline{FI}}_{U s e d}} ,$$
wherein for the fluorescence microscope to be adjusted, the correction factor K_{FI} is configured to render each adjustable system parameter, which depends linearly on the fluorescence image intensity, for the adjustment of the fluorescence image intensity correctable,
wherein
the qualified system reference sample is in the form of a homogeneously fluorescent glass substrate with emission bands between 400 nm and 850 nm.

13. The fluorescence microscope as claimed in claim 12, wherein a radiation source intensity I_{S} of a radiation source of the fluorescence microscope is correctable by I_{S,adjustment}=K_{FI}·I_{S,original} with a correction factor K_{FI} when using the fluorescence microscope to acquire an image of a sample to be examined.

14. The fluorescence microscope as claimed in claim 12, wherein the radiation source is an LED light source, wherein the LED intensity is correctable by I_{LED,adjustment}=K_{FI}·I_{LED,original} with the correction factor K_{FI} when using the fluorescence microscope to acquire an image of a sample to be examined.

15. The fluorescence microscope as claimed in claim 12, wherein an exposure time t is correctable by means of t_{adjustment}=K_{FI}·t_{original} with a correction factor K_{FI} when using the fluorescence microscope to acquire an image of a sample to be examined.
